(19) United States
(12) Patent Application Publication
(10) Pub. No.: US 2019/0251576 A1
(43) Pub. Date: Aug. 15, 2019

(54) TRACKING AND VERIFYING AUTHENTICITY OF AN ASSET VIA A DISTRIBUTED LEDGER

(71) Applicant: Texas Precious Metals LLC, Shiner, TX (US)

(72) Inventors: Tarek I. Saab, Shiner, TX (US); Bruce Kleinman, Mountain View, CA (US); Joshua A. Baker, Yoakum, TX (US); Philipp Fuhrmann, Vancouver (CA)

(21) Appl. No.: 16/023,747

(22) Filed: Jun. 29, 2018

Related U.S. Application Data
(63) Continuation of application No. 15/895,503, filed on Feb. 13, 2018.

(51) Int. Cl. G06Q 30/00; G06Q 20/38

(52) U.S. Cl. CPC G06Q 30/0185; G06Q 20/3829; G06Q 2220/00; G06Q 20/3823; G06Q 20/3825

(57) ABSTRACT

A system for verifying the authenticity of an asset is provided. The system generates asset authentication information that includes an asset print and an asset unique identifier. The system generates the asset print based on analysis of an image of the asset. The system generates an asset signature of the asset authentication information. The system then records the asset authentication information and asset signature in a blockchain. To verify the authenticity of a target asset, the system generates a target asset print by analyzing an image of the target asset. The system retrieves from the blockchain the record with asset authentication information with an asset unique identifier that matches the target asset unique identifier. The system then verifies the signature of the record and verifies that the target asset print matches the asset print of the authentication information. If verified, the system indicates that target asset is authentic.

### CROSS-REFERENCE TO RELATED APPLICATION

This is a continuation application of U.S. patent application Ser. No. 15/895,503, filed on February 13, 2018, which is hereby incorporated by reference in its entirety.

### BACKGROUND

It is important in many industries to ensure that a target asset is the actual asset that it is purported to be. For example, when a person wants to purchase a diamond, the person may want ensure that a proffered grading report that is based on the International Diamond Grading System developed by the Gemological Institute of America (“GIA”) is really a grading report for the diamond to be purchased. Such a grading report may include a serial number assigned by the GIA and inscribed on the diamond and physical dimensions of the diamond such as its shape, measurements, weight, and so on. Unfortunately, when purchasing a diamond, a person may be presented with a counterfeit diamond that has been inscribed with the same serial number as a subject diamond that is the subject of a grading report but is of a much lower quality than the subject diamond. As a result, the purchaser may unwittingly pay the price of a high-quality diamond for a low-quality diamond because of a fraudulent assertion about the authenticity of the diamond to be purchased.

Many other types of assets are susceptible to similar fraudulent assertions about their authenticity. A unit of a precious metal (i.e., the asset) may be a coin, a bar (also referred to as a bullion or an ingot), and so on. A precious metal may be gold, silver, platinum, palladium, and so on. A common problem with precious metals is that an assertion about the quality of a unit of a precious metal may be fraudulent. For example, a fraudster may assert that a proffered gold bar has a purity of 999.9 when in fact the gold bar has a purity of only 900.0. An unsophisticated purchaser may not be able to determine that the actual purity is 10% less that the asserted purity. To help purchasers in assessing the value of a unit of gold, manufacturers of units of gold often embed in the unit (e.g., engrave or inscribe on) information indicating its purity and the weight of the unit (e.g., 1 troy oz.) along with the name of the manufacturer, a logo of the manufacturer, a serial number, and so on as an indication of the origin of the unit.

Unfortunately, a counterfeiter may simply manufacture counterfeit units of gold that are embedded with similar information (including purity and the name and logo of a reputable manufacturer) but actually have a much lower purity than the embedded purity information would indicate. As the price of gold and other precious metals increase, such counterfeiting of units of precious metals is becoming increasingly common. It would be desirable to have a way to quickly verify the authenticity of a unit of precious metal or other type of asset.

### BRIEF DESCRIPTION OF DRAWINGS

FIG. 1 is a diagram of an example gold bar with embedded information.

FIG. 2 is a flow diagram that illustrates the overall processing of the AA system in some embodiments.

FIG. 3 is a block diagram illustrating storing of asset authentication information in a blockchain.

FIG. 4 is a block diagram illustrating components of the AA system in some embodiments.

FIG. 5 is a flow diagram that illustrates the processing of a register asset component of the AA system in some embodiments.

FIG. 6 is a flow diagram that illustrates the processing of a generate asset print component of the AA system in some embodiments.

FIG. 7 is a flow diagram that illustrates the processing of an authenticate asset component of an AA application in some embodiments.

FIG. 8 is a flow diagram that illustrates the processing of an identify feature set component of the AA system in some embodiments.

### DETAILED DESCRIPTION

### Overview of Asset Authentication

A method and system for verifying the authenticity of an asset is provided. In some embodiments, an asset authentication (“AA”) system generates asset authentication information for each asset (e.g., gold bar) that includes a “digital fingerprint,” referred to as an “asset print,” for the asset and an asset unique identifier (e.g., the name of the manufacturer and a serial number), which is embedded in the asset. The AA system generates an asset signature (e.g., manufacturer signature) of the asset authentication information. The AA system then records the asset authentication information and its asset signature in a distributed ledger such as a blockchain. The AA system generates the asset print based on physical characteristics of the asset such as the distance between embedded characters and the width of a border of the asset. The AA system may identify the physical characteristics of the asset by analyzing an image of the asset. To verify the authenticity of a target asset, an image of the target asset is acquired (e.g., via a camera of a smartphone). The AA system may then analyze the image to identify its physical characteristics and its target asset unique identifier. The target asset unique identifier may also be input to the AA system by a user (e.g., entering a manufacturer and serial number) rather than derived from the analysis of the image. The AA system generates a target asset print for the target asset and retrieves from the distributed ledger the record with the asset authentication information that includes an asset unique identifier that is the same as the target asset unique identifier. The AA system then verifies the signature of the record and compares the target asset print to the asset print of the authentication information. If the signature is verified and the asset prints match, then the AA system has verified the authenticity of the target asset.

### Distributed Ledger Overview

In some embodiments, a manufacturer of assets uses the AA system to record authentication information for its assets in a distributed ledger that is a blockchain, such as the blockchain of the bitcoin system. The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key (or a cryptographic hash, referred to herein as a “hash,” of the public key, referred to as an “address”) of the new owner, is digitally signed by the owner with the owner's private key to transfer ownership to the new owner, as represented by the new owner's public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner is defined as the entity that has possession of the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique, referred to as “mining,” to generate a nonce that is added to the block when it is created. A bitcoin ledger is sometimes referred to as an Unspent Transaction Output (“UTXO”) set because it tracks the output of all transactions that have not yet been spent.

The bitcoin system is an example of a blockchain-based distributed ledger system. Other blockchain-based distributed ledger systems include Ethereum, Litecoin, Ripple, IOTA, Hyperledger, and so on, each of which support a type of cryptocurrency. To enable more complex transactions than the bitcoin system can support, some distributed ledger systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard.

Some distributed ledgers are not based on a blockchain and store transactions on a limited number of nodes, such as nodes of the parties to a transaction. With such distributed ledgers, a notary node may notarize transactions after validating each transaction. For example, the notary node may ensure that inputs to a transaction have not already been consumed and that the transaction has been signed by the required parties.

### Details of Asset Authentication

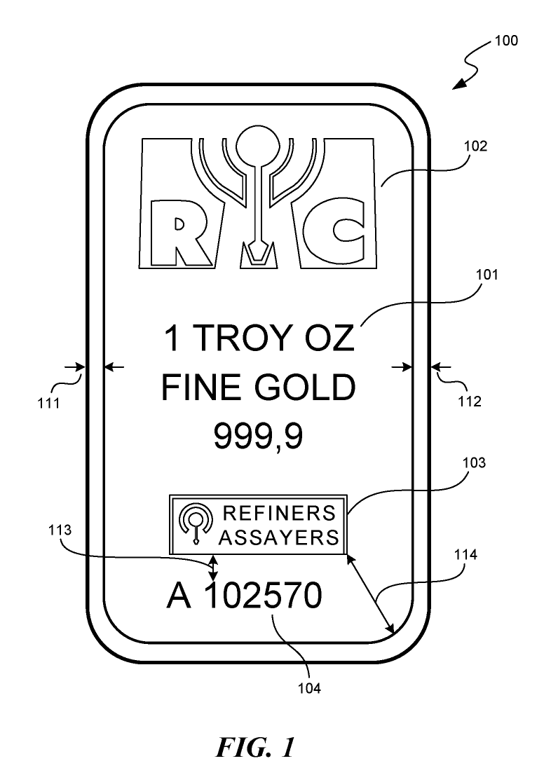

FIG. 1 is a diagram of an example gold bar with embedded information. The gold bar 100 is embedded with various types of information such as weight and purity information 101, logo 102 of the mint (i.e., manufacturer) that produced the bar, the assayer organization 103 that the mint is a member of, and a serial number 104 of the gold bar assigned by the mint. The gold bars of different mints may be embedded with different sets of information that may include name of the mint, country of origin, date of minting, and so on. FIG. 1 also illustrates physical characteristics or features of a gold bar that may be used to generate an asset print. The physical characteristics include thicknesses 111 and 112 of the border or reeded edge at various locations, distance 113 between the serial number and assayer name, and distance 114 between a corner and assayer name. The physical characteristics may also include height, width, and font of certain characters (e.g., serial number), distances between any characters, variations between characters and standard characters, variations between characters themselves, and so on.

In some embodiments, the AA system acquires an image of an asset at the completion of its manufacture. For example, a mint may have a camera that takes pictures of each gold bar after being minted. The AA system analyzes the image of an asset to identify feature values for each feature in a feature set that are derived from the physical characteristics of the asset. The AA system generates the asset print for the asset from the identified feature values. For example, the feature values may be the thickness of the right border at its midpoint and the height and width of the assayer name. To generate the asset print, the AA system may generate a hash from the feature values. For example, the feature values may be represented by a string of 128 characters, and the hash may be 256 bits.

After generating the asset print for an asset, the AA system generates a transaction to be recorded in a blockchain. The transaction includes an authentication data structure that stores the asset authentication information and a manufacturer signature of the asset identification information. The asset identification information includes the asset print of the asset and an asset unique identifier. The asset unique identifier may be a combination of a manufacturer identifier of the manufacturer of the asset and an asset identifier (e.g., serial number) assigned by the manufacturer. The AA system generates the manufacturer signature by inputting to a signature algorithm a private key of a private/public key pair of the manufacturer and the asset identification information. The signature algorithm may be, for example, an Elliptical Curve Digital Signature Algorithm. If the blockchain is the bitcoin blockchain, then the authentication data structure can be recorded as part of the output script of a transaction. If the blockchain is the Ethereum blockchain, then the authentication data structure can be recorded as part of the state of a transaction recorded by a smart contract. The AA system may assume that the transaction has been successfully recorded after a certain number of confirmations (e.g., six). The AA system may also maintain an index that maps each asset unique identifier to the location (e.g., block height) in the blockchain for rapid retrieval of transactions based on their asset unique identifiers.

A person who wants to verify the authenticity of a target asset may download an application of the AA system (“AA application”) to their personal computing device (e.g., smartphone or tablet). The AA application provides a user interface for acquiring an image of the target asset using the camera of the computing device. The AA application may then preprocess or normalize the image to facilitate extracting feature values for the features used to generate the asset print. The AA application may include functionality to perform or may integrate with standard tools (e.g., Amazon Rekognition or IBM Visual Recognition tools) to perform preprocessing to ensure that the image is of sufficient quality for authentication based on the feature set. After collecting the feature values, the AA application generates a target asset print for the target asset from the feature values and identifies the target asset unique identifier for the target asset. The AA application then retrieves from the blockchain the transaction with an asset unique identifier that matches the target asset unique identifier. To speed up the process of identifying the transaction, the AA application may, for example, send to a server of the manufacturer of the asset a request for the identification of the block that contains the transaction matching the target asset unique identifier. Upon receiving the identification of the block, the AA application can directly access that block without having to search through the entire blockchain.

After the transaction is retrieved, the AA application can then use the public key of the manufacturer (e.g., based on a public key certificate) to ensure that the manufacturer signature indicates that it was generated from the asset identification information of the transaction and the private key of the manufacturer. The AA application then compares the target asset print to the asset print of the transaction. If they match, then the AA application informs the person that the target asset has been authenticated as being the asset identified by the asset unique identifier. The transaction may include additional information that is provided to the person requesting the authentication, such as an image of the asset, date of manufacture, purity, and so on.

In some embodiments, an organization (e.g., a “trusted agent”) other than the manufacturer of an asset may record the asset authentication information in a distributed ledger. For example, a registration organization may receive images of assets generated by various manufacturers. The registration organization may then generate an asset print and record in a distributed ledger a transaction that includes the asset authentication information with the asset print and the asset unique identifier and includes the organization's signature using a private key of the organization on the asset authentication information. The organization may also employ different private keys for different manufacturers. The different private keys may be generated from a master private key of the organization using a hierarchical deterministic key algorithm. The registration organization may be responsible for identifying the feature sets to use for each manufacturer and asset type.

In some embodiments, the AA system may employ different feature sets used to generate the asset print for different asset types and different manufacturers. For example, the feature set for a gold coin may be different from that for a gold bar. Also, each manufacturer may select a feature set that produces asset prints that are unique for that manufacturer. To identify a feature set, a manufacturer may collect sample images of sample assets. The AA system may then, for each feature set, generate an asset print for each sample image. The AA system then analyzes the asset prints for each feature set to identify the feature set that results in asset prints that uniquely identify each asset and that are reproducible by the AA application.

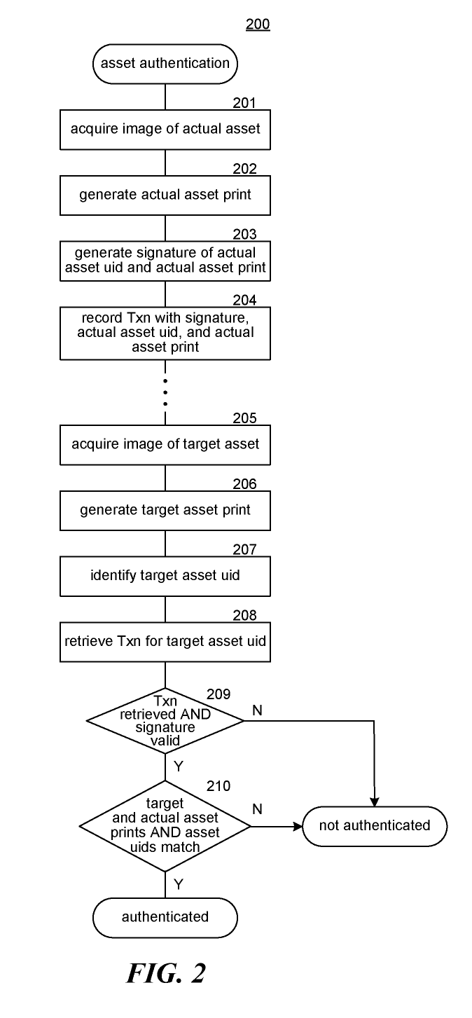

FIG. 2 is a flow diagram that illustrates the overall processing of the AA system in some embodiments. The AA system 200 records in a distributed ledger transactions with asset authentication information for assets and allows the authentication of assets based on the recorded transactions. Blocks 201-204 illustrate processing typically performed by the manufacturer of an asset. In block 201, the AA system acquires an image of an actual asset, for example, at the end of manufacture of the asset. In block 202, the AA system generates an actual asset print for the asset based on feature values derived from analysis of the image. In block 203, the AA system generates a manufacturer signature over the combination of the actual asset unique identifier and the actual asset print. In block 204, the AA system records in a blockchain a transaction that includes the manufacturer signature, the actual asset unique identifier, and the actual asset print. Blocks 205-210 illustrate processing typically performed by a device of a user who wants to verify the authenticity of an asset. In block 205, the AA system acquires an image of a target asset whose authenticity is to be verified. In block 206, the AA system generates a target asset print for the target asset based on feature values derived from analysis of the image. In block 207, the AA system identifies a target asset unique identifier for the target asset. The AA system may identify the target asset unique identifier based on analysis of the image or may receive the target asset unique identifier from the user who identifies it based on an embedding in the asset. In block 208, the AA system retrieves from the blockchain a transaction whose asset unique identifier matches the target asset unique identifier. In decision block 209, if the transaction was retrieved or the manufacturer signature is valid, then the AA system continues at block 210 else the AA system indicates that the target asset was not authenticated. In decision block 210, if the target and actual asset prints and the asset unique identifiers match, then the AA system indicates that the target asset was authenticated, else the AA system indicates that the target asset was not authenticated.

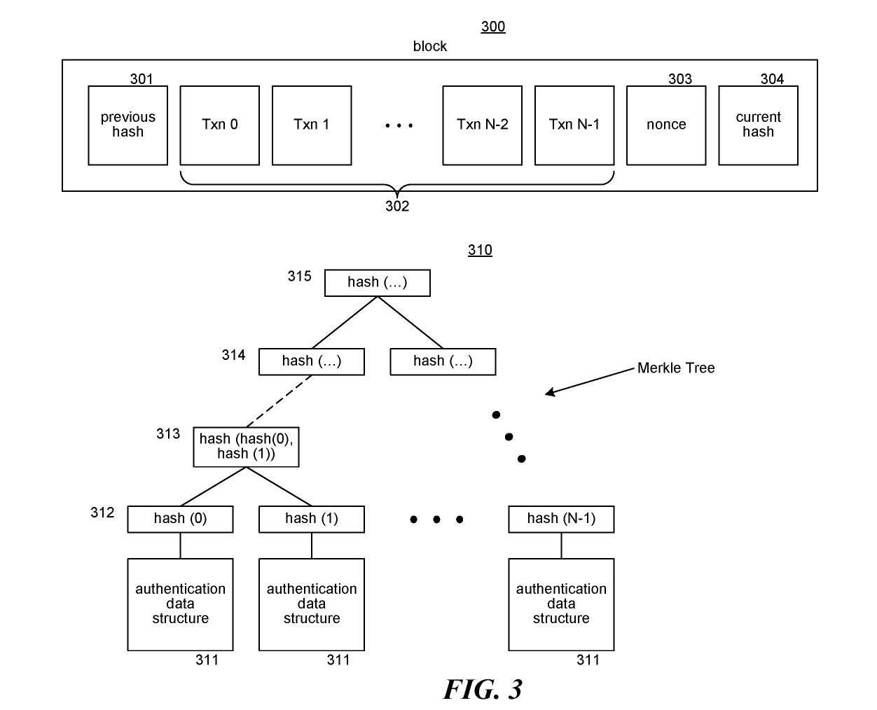

FIG. 3 is a block diagram illustrating storing of asset authentication information in a blockchain. A block 300 represents a block of a blockchain. The block includes a previous hash 301, transactions 302, a nonce 303, and a current hash 304. The previous hash is a hash of the previous transactions in the blockchain. The nonce represents a value identified when the block was mined to produce the current hash for the block with certain characteristics (e.g., a certain number of leading zeros). Each transaction may include the authentication information of an asset. Alternatively, the asset authentication information and manufacturer signature may be stored off-chain, and only the hash of the combination of the asset authentication information and the manufacturer signature is stored within a transaction. A Merkle tree 310 represents a data structure for storing asset authentication information of assets off-chain. Each leaf node 311 of the Merkle tree contains the authentication data structure for an asset. A manufacturer may periodically generate a Merkle tree for assets that it manufactures and record the root hash of the Merkle tree in the blockchain. The non-leaf nodes 312, 313, 314, and 315 of the Merkle tree contain the hash of its child node or child nodes. The Merkle tree itself may or may not be stored at a node of the blockchain. The transaction that records the root hash may also identify the manufacturer and its asset identifier range of assets represented by the Merkle tree. To verify the authenticity of a target asset, an AA application identifies the transaction with the root hash for the manufacturer of the target asset with an asset identifier range that encompasses the target asset identifier. The AA application can then search the Merkle tree for a leaf node that matches the target asset identifier. If the asset identifiers are in order, then the AA application can follow a path uniquely defined by the target asset identifier from the root node to the leaf node for the target asset identifier. In this way, the AA application need not conduct a search of the Merkle tree.

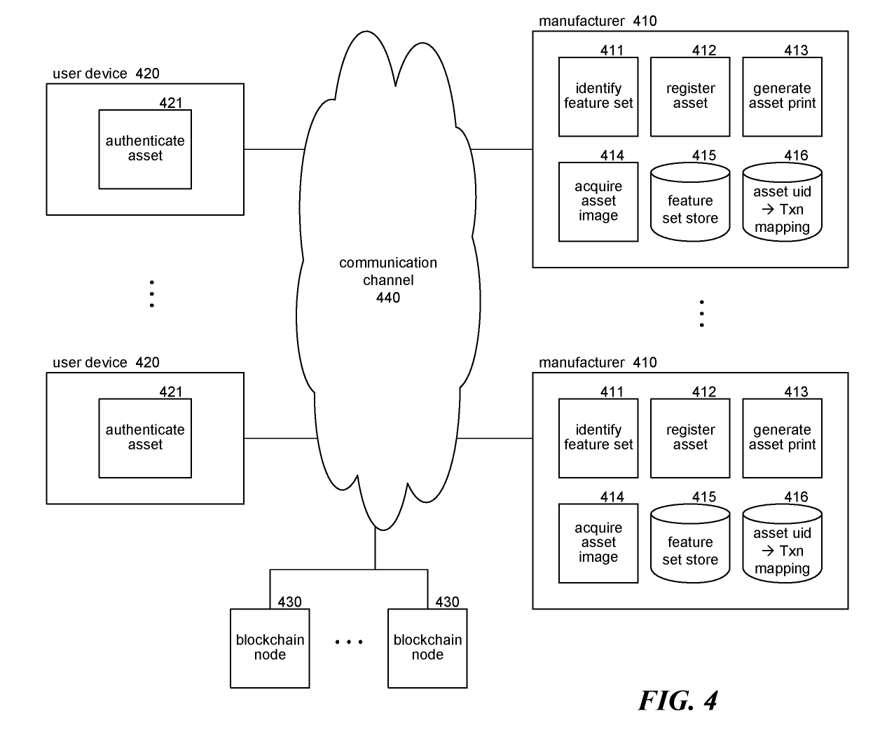

FIG. 4 is a block diagram illustrating components of the AA system in some embodiments. The AA system includes components of a manufacturer system 410 and components of a user device 420. The manufacturer systems, the user devices, and blockchain nodes 430 are connected via a communication channel 440. The manufacturer system includes an identify feature set component 411, a register asset component 412, a generate asset print component 413, and an acquire asset image component 414. The manufacturer system also includes a feature set store 415 and an asset unique identifier to transaction mapping store 416. The identify feature set component analyzes different feature sets to select an appropriate feature set for a type of asset of a manufacturer. The register asset component controls the overall registration of an asset by recording a transaction in the blockchain. The register asset component invokes the generate asset print component to generate asset prints for manufactured assets. The acquire asset image component acquires an image of an asset and performs preprocessing of the image. The feature set store stores an identification of the feature set used for each asset type of the manufacturer. The asset unique identifier to transaction mapping store is an index that includes the identity of the block that stores the authentication data structure for each asset unique identifier. An authenticate asset component 421 of the user device controls the overall authentication of a target asset.

The computing systems (e.g., client devices and server devices) on which the AA system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the AA system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys. The computing systems may also include a secure enclave for verification and execution of code of the AA system. For example, the secure enclave of a user device may ensure that the code of the AA application of the device is correct by generating a hash of the code and comparing the hash to a published hash for the code for the AA application.

The AA system may be described in the general context of computer-executable instructions, such as program modules and components, executed by one or more computers, processors, or other devices. Generally, program modules or components include routines, programs, objects, data structures, and so on that perform tasks or implement data types of the AA system. Typically, the functionality of the program modules may be combined or distributed as desired in various examples. Aspects of the AA system may be implemented in hardware using, for example, an application-specific integrated circuit (“ASIC”) or field programmable gate array (“FPGA”).

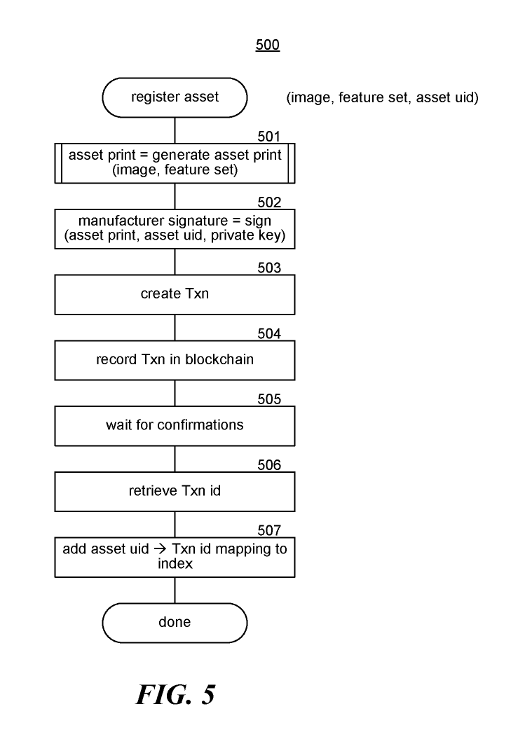

FIG. 5 is a flow diagram that illustrates the processing of a register asset component of the AA system in some embodiments. A register asset component 500 is invoked, passing an indication of an image, a feature set, and an asset unique identifier for a recently manufactured asset. The register asset component controls the registration of an asset. In block 501, the component invokes the generate asset print component, passing an indication of the image and the feature set, to generate an asset print of the asset based on analysis of the image. In block 502, the component invokes a signature component, passing an indication of the asset print, the asset unique identifier, and a private key of the manufacturer. The signature component returns the manufacturer signature. In block 503, the component creates a transaction that includes the manufacturer signature and authentication information that includes the asset print and the asset unique identifier. In block 504, the component directs the transaction to be recorded in the blockchain. In block 505, the component waits for sufficient confirmations of the recording of the transaction in the blockchain. In block 506, the component retrieves an identifier of the block in which the transaction is recorded (e.g., block height). In block 507, the component adds a mapping of the asset unique identifier to the identifier of the block to the asset unique identifier to transaction mapping store and then completes.

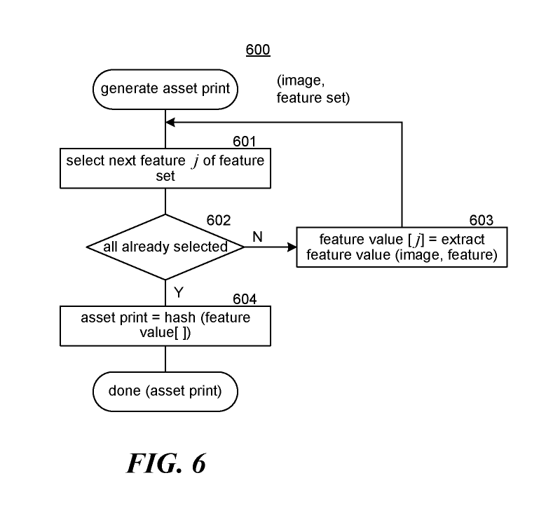

FIG. 6 is a flow diagram that illustrates the processing of a generate asset print component of the AA system in some embodiments. A generate asset print component 600 is passed an indication of an image and a feature set and generates an asset print based on the image and the feature set. In block 601, the component selects the next feature of the feature set. In decision block 602, if all the features have already been selected, then the component continues at block 604, else the component continues at block 603. In block 603, the component calculates the feature value for the selected feature of the image and then loops to block 601 to select the next feature. In block 604, the component sets the asset print for the asset represented by the image to the hash of the feature values and completes, returning the asset print.

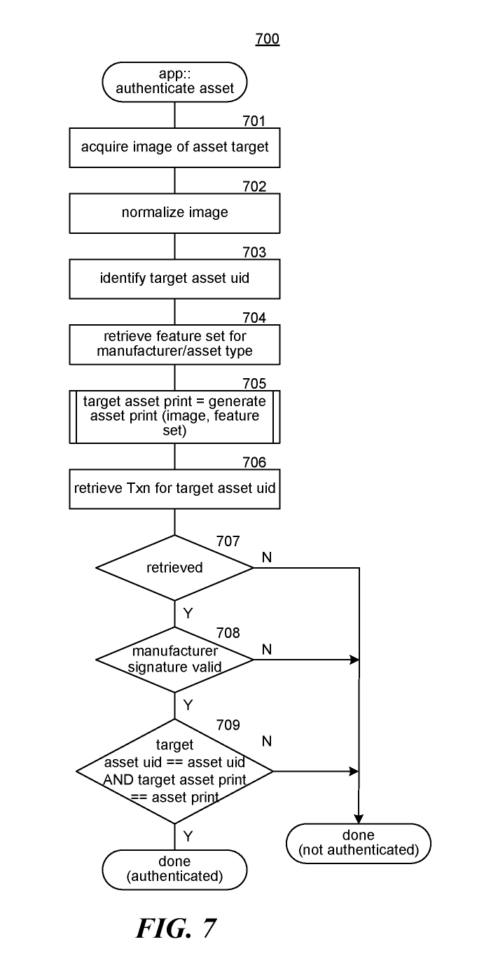

FIG. 7 is a flow diagram that illustrates the processing of an authenticate asset component of an AA application in some embodiments. An authenticate asset component 700 is executed on a user device to authenticate a target asset. In block 701, the component acquires an image of the target asset. In block 702, the component preprocesses the image to ensure that it is sufficient quality (e.g., lighting intensity, camera angle, shadows, and resolution) for generating an asset print. If the image of not of sufficient quality, then the component may notify the user of the problem in quality so that the user can acquire another image. In block 703, the component identifies the target asset unique identifier for the target asset. The target asset unique identifier may be identified from the image, for example, using optical character recognition and/or matching logos to those of known manufacturers or may be identified based on input from a user. In block 704, the component retrieves the feature set for the manufacturer and asset type. In some embodiments, a manufacturer may keep the feature set used to generate the asset prints confidential to help prevent counterfeiting of assets that have the same asset print as a legitimate asset. In block 705, the component generates a target asset print by invoking the generate asset print component, passing an indication of the image and the feature set. In block 706, the component retrieves the transaction from the blockchain for the target asset unique identifier. In decision block 707, if the transaction is retrieved, the component continues at block 708, else the component indicates that the target asset has not been authenticated. In decision block 708, if the manufacturer signature of the transaction is valid, then the component continues at block 709, else the component indicates that the target asset has not been authenticated. In decision block 709, if the target asset unique identifier matches the asset unique identifier and the target asset print matches the asset print, then the component indicates that the target asset has been authenticated, else the component indicates that the target asset has not been authenticated.

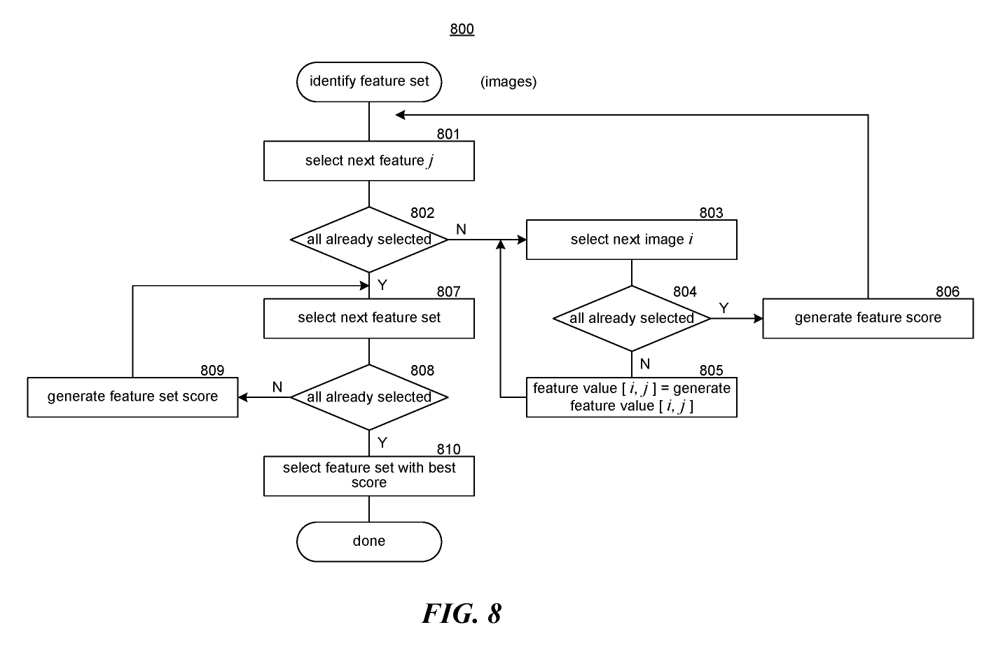

FIG. 8 is a flow diagram that illustrates the processing of an identify feature set component of the AA system in some embodiments. An identify feature set component 800 is invoked, passing an indication of sample images, and identifies a feature set to use in generating asset prints for assets represented by the images. In block 801, the component selects the next feature of possible features to be included in a feature set. In decision block 802, if all the features have already been selected, then the component continues at block 807, else the component continues at block 803. In blocks 803-806, the component loops, generating feature values for the selected feature for each sample image and generating a score for the feature. In block 803, the component selects the next sample image. In decision block 804, if all the sample images have already been selected, then the component continues at block 806, else the component continues at block 805. In block 805, the component generates a feature value for the selected feature of the selected sample image and then loops to block 803 to select the next sample image. In block 806, the component generates a feature score for the selected feature indicating how well the feature distinguishes the assets represented by the sample images. For example, the score may be based on the statistical variance or deviation of the feature values. In such a case, a larger variance may indicate a more suitable feature for the feature set. In block 807, the component selects the next feature set. For example, the component may loop, selecting all combinations of features. In decision block 808, if all the feature sets have already been selected, then the component continues at block 810, else the component continues at block 809. In block 809, the component generates a feature set score based on the generated feature scores for the features of the feature set and then loops to block 807 to select the next feature set. The feature set score may be based on a statistical variance or deviation of the feature score of features of the feature set. In block 810, the component selects the feature set with the best feature set score and then completes.

The following paragraphs describe various embodiments of aspects of the AA system. An implementation of the AA system may employ any combination of the embodiments. The processing described below may be performed by a computing device with a processor that executes computer-executable instructions stored on a computer-readable storage medium that implements the AA system.

In some embodiments, a method performed by a computing system for creating an asset signature of an asset is provided. The method generates an asset unique identifier for the asset. The asset unique identifier is embedded in the asset. The method accesses an image of the asset. For each of a plurality of features, the method generates a feature value for the feature based on analysis of the image. The method generates an asset print of the asset from the generated feature values. The method also generates an asset signature for the asset by signing a combination of the asset print and the asset unique identifier with a private key of a private/public key pair. In some embodiments, the asset is a unit of a precious metal. In some embodiments, the asset unique identifier is a combination of a manufacturer identifier of a manufacturer of the asset and an asset identifier of the asset assigned by the manufacturer. In some embodiments, the asset identifier is a serial number. In some embodiments, the asset unique identifier is embedded in the asset. In some embodiments, the embedding is an engraving. In some embodiments, the asset print is generated by generating a hash of the feature values. In some embodiments, the features are selected from a group consisting of thickness of a border of the asset, distance from an edge to an engraving on the asset, distance between engravings on the asset, and variations in characters engraved on the asset from standard characters. In some embodiments, the method further records in a distributed ledger a transaction that identifies the asset signature, the asset print, and the asset unique identifier. In some embodiments, the method further acquires a target image of a target asset. For each of the plurality of features, the method generates a target feature value for the feature based on analysis of the target image. The method generates a target asset print of the target asset from the generated target feature values. The method identifies a target asset unique identifier. The method retrieves from the distributed ledger the transaction based on its asset unique identifier matching the target asset unique identifier. The method validates the asset signature of the retrieved transaction using the public key of the private/public key pair. When the asset signature is valid and when the target asset print matches the asset print, the method indicates that the target asset has been authenticated as being the asset. In some embodiments, the asset is a unit of precious metal, the asset print is generated by generating a hash of the feature values, and the asset unique identifier is a combination of a manufacturer identifier of a manufacturer of the asset and an asset identifier of the asset assigned by the manufacturer, and the method further records in a distributed ledger a transaction that identifies the asset signature, the asset print, the manufacturer identifier, and the asset identifier.

In some embodiments, a method performed by a computing system for authenticating a target asset is provided. The method acquires a target image of the target asset. For each of a plurality of features, the method generates a target feature value for the feature based on analysis of the target image. The method generates a target asset print for the target asset based on the generated target feature values. The method identifies a target asset unique identifier of the target asset. The method accesses a transaction stored in a distributed ledger. The transaction includes the target asset unique identifier, an asset signature, and an asset print. The method validates the asset signature of the accessed transaction. When the asset signature is valid and when the target asset print matches the asset print, the method indicates that the target asset has been authenticated. In some embodiments, the computing system is a user device of a user. In some embodiments, the computing system comprises a user device and a server and wherein the user device acquires the target image, sends to the server the target asset unique identifier, and receives an indication of where the transaction is recorded in distributed ledger. In some embodiments, the asset signature comprises a combination of the asset print and the target asset unique identifier signed with a private key of a private/public key pair. In some embodiments, the target asset unique identifier includes a target manufacturer identifier of a manufacturer of the target asset and a target asset identifier of the target asset assigned by the manufacturer. In some embodiments, the private key is a private key of the manufacturer. In some embodiments, the validating of the asset signature and the indicating that the target asset has been authenticated is performed by a smart contract associated with the transaction. In some embodiments, the transaction is recorded in the distributed ledger by a manufacturer of the target asset.

In some embodiments, a computer-readable storage medium storing a transaction representing an asset is provided. The transaction comprises an asset print generated from feature values of features of the asset, a manufacturer identifier of a manufacturer of the asset, an asset identifier of the asset assigned by the manufacturer, and an asset signature that is a combination of the asset print, the manufacturer identifier, and the asset identifier and that is signed by a private key of a private/public key pair of the manufacturer. In some embodiments, the transaction is recorded in a distributed ledger. In some embodiments, the distributed ledger is a blockchain. In some embodiments, the manufacturer identifier and the asset identifier are embedded in the asset. In some embodiments, the manufacturer identifier and the asset identifier are represented in the transaction as plaintext. In some embodiments, the transaction further comprises a public key certificate for the public key of the private/public key pair.

In some embodiments, a computing system is provided for recording in a distributed ledger authentication information for an asset. The computing system comprises one or more computer-readable storage mediums storing computer-executable instructions and one or more processors for executing the computer-executable instructions stored in the one or more computer-readable storage mediums. The instructions control controlling the computing system to access an asset unique identifier of the asset and an image of the asset, the asset unique identifier embedded in the asset. The instructions control controlling the computing system to generate an asset print based on features of the asset derived from the image. The instructions control controlling the computing system to generate an asset signature for the asset by signing a combination of the asset print and the asset unique identifier with a private key of a private/public key pair. The instructions control controlling the computing system to direct recording in a distributed ledger information that includes the asset signature, the asset print, and the asset unique identifier. In some embodiments, the asset is a unit of a precious metal. In some embodiments, the asset unique identifier is a combination of a manufacturer identifier of a manufacturer of the asset and an asset identifier of the asset assigned by the manufacturer. In some embodiments, the asset print is a hash of the feature values of the features. In some embodiments, the distributed ledger is a blockchain.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, the AA system may be adapted to authenticate various types of assets such as precious metals, gemstones, fine art, rare currency (e.g. rare coins and paper money), rare stamps, and so on. As another example, a manufacturer or other organization may store asset authentication information for assets without using a distributed ledger. In such a case, the asset authentication information may be stored on a server of the organization. When requested by an AA application executing on a user device to provide the asset print associated with an asset unique identifier, the server may use the asset unique identifier or the asset identifier to retrieve the associated asset print and send the asset print to the AA application. Also, a public key certificate of the manufacturer of an asset may be stored in a transaction to facilitate validating the manufacturer signature of a transaction. Accordingly, the invention is not limited except as by the appended claims.

1. A method performed by a computing system for creating an asset signature of an asset, the method comprising:
accessing an asset unique identifier for the asset;
accessing an image of the asset;
for each of a plurality of features of the asset, generating a feature value for the feature based on the image, each feature of the asset being a asset;
generating an asset print of the asset from the generated feature values;
generating an asset signature for the asset by signing a combination of the asset print and the asset unique identifier with a private key of a private/public key pair, and
storing the asset signature for authentication of the asset.

2. The method of claim 1 wherein the asset is a unit of a precious metal.

3. The method of claim 1 wherein the asset unique identifier is a combination of a manufacturer identifier of a manufacturer of the asset and an asset identifier of the asset assigned by the manufacturer.

4. The method of claim 3 wherein the asset identifier is a serial number.

5-6. (canceled)

7. The method of claim 1 wherein the asset print is generated by generating a hash of the feature values.

8. The method of claim 1 wherein the features are selected from a group consisting of thickness of a border of the asset, distance from an edge to an engraving on the asset, distance between engravings on the asset, and variations in characters engraved on the asset from standard characters.

9. The method of claim 1 further comprising recording in a distributed ledger a transaction that includes an indication of the asset signature, the asset print, and the asset unique identifier.

10. The method of claim 9 further comprising:
acquiring a target image of a target asset;
for each of the plurality of features of the target asset, generating a target feature value for the feature based on the target image;
generating a target asset print of the target asset from the generated target feature values;
identifying a target asset unique identifier;
retrieving from the distributed ledger the transaction based on the asset unique identifier of the transaction matching the target asset unique identifier;
validating the asset signature of the retrieved transaction using the public key of the private/public key pair;
determining that the asset signature is validated based on the validating and that the target asset print matches the asset print; and
based on that determination, indicating that the target asset has been authenticated as being the asset.

11. The method of claim 1 wherein the asset is a unit of precious metal, the asset print is generated by generating a hash of the feature values, and the asset unique identifier is a combination of a manufacturer identifier of a manufacturer of the asset and an asset identifier of the asset assigned by the manufacturer, and further comprising recording in a distributed ledger a transaction that that includes an indication of the asset signature, the asset print, the manufacturer identifier, and the asset identifier.

12-30. (canceled)

31. A computing system for creating an asset signature of an asset, the computing system comprising:
one or more processors,
one or more computer-readable storage mediums storing computer-executable instructions that when executed by the one or more processors cause the computing system to perform:
accessing an asset unique identifier for the asset;
accessing an image of the asset;
for each of a plurality of features of the asset, generating a feature value for the feature based on the image, each feature of the asset is a physical characteristic of the asset generated during creation of the asset;
generating an asset print of the asset from the generated feature values; and
generating an asset signature for the asset by signing a combination of the asset print and the asset unique identifier with a private key of a private/public key pair.

32. The computing system of claim 31 wherein the asset is a unit of a precious metal.

33. The computing system of claim 31 wherein the asset unique identifier is a combination of a manufacturer identifier of a manufacturer of the asset and an asset identifier of the asset assigned by the manufacturer.

34. The computing system of claim 31 wherein the computer-executable instructions that when executed by the one or more processors further cause the computing system to perform:
acquiring a target image of a target asset;
for each of the plurality of features of the asset, generating a target feature value for the feature based on the target image;
generating a target asset print of the target asset from the generated target feature values;
identifying a target asset unique identifier;
retrieving from a distributed ledger the transaction based on the asset unique identifier of the transaction matching the target asset unique identifier;
validating the asset signature of the retrieved transaction using the public key of the private/public key pair;
determining that the asset signature is validated based on the validating and that the target asset print matches the asset print, and
based on that determination, indicating that the target asset has been authenticated as being the asset.

35. The computing system of claim 31 wherein the computer-executable instructions that when executed by the one or more processors further cause the computing system to perform recording in a distributed ledger a transaction that includes an indication of the asset signature, the asset print, and the asset unique identifier.

36. The computing system of claim 35 wherein the distributed ledger is a blockchain.

37. The computing system of claim 31 wherein the generating of the asset print, includes generating a hash of the feature values of the features.
